(19) United States
(12) Patent Application Publication
(10) Pub. No.: US 2025/0040551 A1
(43) Pub. Date: Feb. 6, 2025

(54) LIQUID SEED TREATMENT

(71) Applicant: SYNGENTA CROP PROTECTION AG, Basel (CH)

(72) Inventors: Sandy BAKER, Singapore (SG); Joseph KUZNIA, Stanton, MN (US); Henry AGBAJE, Greensboro, NC (US)

(73) Assignee: SYNGENTA CROP PROTECTION AG, Basel (CH)

(21) Appl. No.: 18/717,877

(22) PCT Filed: Dec. 1, 2022
(86) PCT No.: PCT/EP2022/083989

§ 371 Date: Jun. 7, 2024

Related U.S. Application Data
(60) Provisional application No. 63/287,274, filed on Dec. 8, 2021.

(30) Foreign Application Priority Data
Mar. 17, 2022 (EP) 22162796.1

(51) Int. Cl. A01N 43/56; A01N 25/04; A01N 37/22; A01N 43/36; A01N 43/54; A01N 43/653; A01P 3/00

(52) U.S. Cl. CPC A01N 43/56; A01N 25/04; A01N 37/22; A01N 43/36; A01N 43/54; A01N 43/653; A01P 3/00

(57) ABSTRACT

The disclosure related to seed treatment formulations and their methods of use. In more specific embodiments, the disclosure relates to liquid seed treatment formulations for use in peanuts.

### TECHNICAL FIELD

The disclosure relates to agrochemical formulations and their methods of use. In particular, the disclosure relates to seed treatment formulations, and more specifically, liquid seed treatments. In specific embodiments, the agrochemical formulations are for use on peanuts.

### BACKGROUND

Peanut seeds should be treated with a fungicide to reduce the incidence of seed-transmitted and soilborne seedling diseases prior to planting. Despite the importance of seed treatments, the fundamental seed treatment for peanuts has not changed in years. Commonly, peanut seeds are treated using standard dust seed treatment. However, such dust treatments have several downsides including difficulty metering/coating seeds and off target dust residues. These challenges can increase the technical skill and expense associated with coating peanut seeds. Despite these downsides, dust treatments remain the primary application method.

While scientists have tried to formulate seed treatments for peanuts as a liquid composition, see for example, U.S. Pat. No. 4,372,080, these liquid treatments do not produce satisfactory results. For instance, peanut seeds treated with liquid compositions tend to have higher split rates of the seed (i.e., the two halves of the peanut seed split apart) as compared to untreated seeds. Previous liquid compositions additionally tended to result in improper water absorption. In particular, treated seeds had excess water absorption resulting in worse germination/seed health as compared to untreated seeds. In addition, liquid seed treatments for peanuts generally had limited drying capabilities thereby increasing the difficulty in handling and processing of seeds. Accordingly, there remains a need for a satisfactory liquid seed treatment for peanuts.

### SUMMARY

Embodiments include a composition, comprising, at least one agrochemically active ingredient, wherein the composition is a liquid, wherein the composition is configured as a seed treatment, and wherein at least one of (a) to (1) is present: peanut seeds treated with the composition experience less than 2% splits when in a 50 lb bag and less than 7% splits when in a tote bag; peanut seeds treated with the composition do not increase the amount of splits by at least 0.25% total as compared to untreated seeds; peanut seeds treated with the composition are about twice as hard as untreated peanuts when measured by a compression clamp test at 15N and room temperature with a DMA (Dynamic Mechanical Analysis) Discovery 850 TA Instruments; peanut seeds treated with the composition have substantially similar water absorption as compared to untreated seeds; peanut seeds treated with the composition absorb about 0.5 to 1 g of water per seed as determined by adding 50 g of seeds to 100 g of water and calculating the absorbed water after 24 and 48 hours; peanut seeds treated with the composition have substantially similar germination as compared to untreated peanuts; peanut seeds treated with the composition have substantially similar vigor as compared to untreated peanuts; the composition dries at a rate of more than 0.115 wt % water loss/min at ambient conditions, peanut seeds treated with the composition have at least about 70% germination, preferably at least 75% germination, and most preferably at least 80% germination; peanut seeds treated with the composition generate less than 0.25 g dust per 100,000 seeds, preferably 0.2 g, and more preferably 0.15 g as measured by a Heubach test; build up of the composition in a seed treater for peanut seeds is less than 0.5 g, preferably less than 0.2 g, and most preferably 0.05 g as measured with retention coupons placed in the treater; and peanut seeds treated with the composition have a fresh flow rate is about at least 70% of untreated seeds. A method including coating or applying the composition of to a peanut and preferably to a peanut seed, and optionally further combing the composition with at least one of a polymeric binder, colorant, or water prior to applying.

A composition, comprising, at least one agrochemically active ingredient between about 2-40% w/w, preferably 5 to 35% w/w, more preferably 10 to 30% w/w, and most preferably 10 to 20% w/w; a drying system/agent between about 2 to 15% w/w, preferably about 3 to 10% w/w, and most preferably about 5 to 8% w/w; a dispersant system/agent between about 2 to 15% w/w, preferably about 3 to 10% w/w, and most preferably 4 to 8% w/w; an oil lubricant system/agent between about 2 to 20% w/w, preferably from about 3 to 15% w/w, and more preferably about 4 to 12% w/w; a wetting system/agent between about 0.5 to 5% w/w, preferably from about 1 to 4% w/w, and more preferably from about 1.5 to 2.5% w/w; an optional antifoam system/agent; an optional thickener system/agent; an optional preservative system/agent; an optional anti-freeze system/agent (more particularly between about 2 to 15% w/w, and more preferably about 5 to 10% w/w); an optional colorant agent/system more particularly present in about 1 to 20% w/w, preferably about 2 to 15% w/w, and more preferably about 3 to 8% w/w; an optional binder system/agent; and water; and wherein the antifoam system/agent; the thickener system/agent; and the preservative system/agent, when added into the composition, total less than about 2% w/w, preferably about 1.5%, and more preferably about 1%. A method including coating or applying the composition of to a peanut, and optionally further combing the composition with at least one of a polymeric binder, colorant, or water prior to applying.

### BRIEF DESCRIPTION OF DRAWINGS

FIG. 1 is a graph depicting water loss over time of certain formulations.

FIGS. 2a and 2b show DMA (Dynamic Mechanical Analysis) Cohesion Tests of peanuts treated with certain formulations.

FIGS. 3a and 3b show germination rates of peanuts treated with certain formulations.

FIGS. 4a-4c and 5a-5c show flow rates of peanuts treated with certain formulations.

FIGS. 6a-6d show dust off rates of peanuts treated with certain formulations.

FIG. 7 shows rate of formulation buildup of formulation in a seed treater.

### DETAILED DESCRIPTION

Before certain embodiments are described in greater detail, it is to be understood that this disclosure is not limited to certain embodiments described, as such may, of course, vary. It is also to be understood that the terminology used herein is for the purpose of describing certain embodiments only, and is not intended to be limiting, since the scope of the present disclosure will be limited only by the appended claims.

Described herein are several definitions. Such definitions are meant to encompass grammatical equivalents.

The use of “or” means “and/or” unless stated otherwise. Furthermore, the use of the terms “comprising,” “having,” “including,” as well as other forms, such as “includes” and “included,” are intended to be inclusive and mean that there may be additional elements other than the listed elements.

As used herein, the term “about” when referring to a measurable value such as an amount, a temporal duration, and the like, is meant to encompass variations. Such variations, however, are dependent on the specific component referred to and the context as understood by a person of ordinary skill in the art.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative methods, and materials are now described.

Each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

### Compositions

### Agrochemicals

Examples include compounds or ingredients registered has being biologically active against an agricultural pest. In general, agrochemical active ingredients include compounds listed in: The Pesticide Manual, 12th edition, 2001, British Crop Protection Council. Agrochemicals include, but are not limited to herbicides, fungicides, other insecticides, bactericides, insect growth regulators, plant growth regulators, nematicides, molluscicides or mixtures of several of these preparations. In general, the amount of agrochemical used in the seed treatment are employed in amounts that do not inhibit germination of the seed or cause phytotoxic damage to the seed. The total amount of active ingredients is generally in the range of from about 0.5-50% w/w. In specific embodiments, the amount of active ingredient is between about 2-40% w/w, preferably about 5-35% w/w, more preferably about 10-30% w/w, and most preferably about 10-20% w/w.

Fungicides useful in the present compositions include any agent useful for the prevention or treatment of fungal pests. Such fungicides may be particularly useful in controlling certain phytopathogenic fungi, and provide high fungicidal activity and relatively low phytotoxicity.

More specifically, fungicides useful in the compositions can include, but are not limited to, diazole, triazole, phenylpyrrole, strobilurin, carboxamide, carboxanilide, especially ortho-substituted carboxanilide, carbamate, anilinopyrimidine, phenoxyquinoline, benzimidazole, systemic and phenylamide fungicides.

Specific fungicides include of pydiflumetofen, azoxystrobin, sedaxane, fludioxonil, mefenoxam (also well-known as metalaxyl-M), and ipconazole, and can be more preferably a combination of pydiflumetofen, azoxystrobin, sedaxane, fludioxonil and mefenoxam.

### Surface Active Agent

The compositions can contain at least about 2% up to about 20% w/w of a surface-active agent. In one embodiment, the aqueous compositions contain from 3% up to about 10% w/w of a surface-active agent.

The surface active agent (a) comprises (a1) at least one anionic surfactant. In general, the anionic surfactant may be any known in the art. Suitable anionic surfactants are in general oligomers and polymers, as well as polycondensates, which contain a sufficient number of anionic groups to ensure their water-solubility. Suitable anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C12-C15 alkanols or polyalkoxylated C12-C15 alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-M-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Specific examples of suitable anionic surfactants include: Geropon T77 (Rhodia) (N-methyl-N-oleoyltaurate Na salt); Soprophor 4D384 (Rhodia) (tristyrylphenol sulphate); Reax 825 (Westvaco) (ethoxylated lignin sulfonate); Stepfac 8171 (Stepan) (ethoxylated nonylphenol phosphate ester); Ninate 401-A (Stepan) (calcium alkylbenzene sulfonate); Emphos CS-131 (Witco) (ethoxylated nonylphenol phosphate ester); and Atphos 3226 (Uniqema) (ethoxylated tridecylalcohol phosphate ester). Suitable anionic surfactants can be prepared by methods known per se and also are commercially available.

The surface-active agent comprising a1) at least one anionic surfactant may optionally further comprise a2) one or more nonionic surfactants. As used herein, “nonionic surfactants” are different compounds from the water-dispersible and water-soluble polymers b) described herein.

Exemplary nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, and mono- and diesters of ethylene glycol and mixtures thereof.

Specific examples of suitable nonionic surfactants include: Genapol X-060 (Clariant) (ethoxylated fatty alcohol); Sorpohor BSU (Rhodia) ethoxylated tristyrylphenol; Makon TD-6 (Stepan) (ethoxylated fatty alcohol); BRIJ 30 (Uniqema) (ethoxylated lauryl alcohol); Witconol CO-360 (Witco) (ethoxylated castor oil); and Witconol NP-60 (Witco) (ethoxylated nonylphenol). Suitable nonionic surfactants can be prepared by methods known per se and also are commercially available.

In addition to anionic and nonionic surfactants, certain cationic or zwitterionic surfactants a3) also are suitable for use in the present invention such as alkanol amides of C8-C18 fatty acids and C8-C18 fatty amine polyalkoxylates, C10-C18 alkyldimethylbenzylammonium chlorides, coconut alkyldimethylaminoacetic acids, and phosphate esters of C8-C18 fatty amine polyalkoxylates.

In one embodiment, a mixture of surfactants (a1), (a2) and optionally (a3) is employed as follows:
(1) 0.1-5% w/w of a wetting agent selected from (a1) at least one anionic surfactant. Suitable anionic surfactant wetting agents include sulfoalkylamides and salts thereof such as N-methyl-N-oleoyltaurate Na salt, alkylaryl sulfonates such as alkylbenzene sulfonates and alkylnaphthalene sulfonates and salts thereof and salts of ligninsulfonic acid;
(2) 1-15% w/w of a dispersing agent selected from (a1) at least one anionic surfactant. Suitable anionic surfactant dispersing agents include sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts;
(3) 1 to 10% w/w of an emulsifying agent selected from (a1) at least one anionic surfactant, (a2) at least one nonionic surfactant and a mixture thereof. Suitable anionic/nonionic surfactant emulsifiers include salts of ethoxylated alkylphenols, polyoxyethylene-polyoxypropylene alkylphenols, (fatty) alcohol ethoxylates and ethoxylated tristyrylphenols.

### Polymers

The composition can also include at least one polymer selected from water-soluble and water-dispersible polymers. Suitable polymers have an average molecular weight of at least about 1,000 up to about 100,000; more specifically at least about 5,000, up to about 100,000. The compositions generally contain from about 0.5% to about 10% w/w of the composition of polymer (b). In a specific embodiment, the compositions contain from about 1.0% up to about 5% w/w of a water-dispersible polymer.

Suitable polymers are selected from:
b1) alkyleneoxide random and block copolymers such as ethylene oxide-propylene oxide block copolymers (EO/PO block copolymers) including both EO-PO-EO and PO-EO-PO block copolymers;
ethylene oxide-butylene oxide random and block copolymers,
C2-6 alkyl adducts of ethylene oxide-propylene oxide random and block copolymers,
C2-6 alkyl adducts of ethylene oxide-butylene oxide random and block copolymers,
b2) polyoxyethylene-polyoxypropylene monoalkylethers such as methyl ether, ethyl ether, propyl ether, butyl ether or mixtures thereof.
b3) vinylacetate/vinylpyrrolidone copolymers,
b4) alkylated vinylpyrrolidone copolymers,
b5) polyvinylpyrrolidone, and
b6) polyalkyleneglycol including the polypropylene glycols and polyethylene glycols.

Specific examples of suitable polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Uniqema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

### Drying Agents

The composition can also comprise, at least about 0.5 and up to about 20% w/w dying agents, more specifically about 1-15% w/w, preferably about 2-10% w/w, and most preferably about 3% w/w of a drying agent or drying system. The drying agent is used to ensure compositions quickly dry onto the seeds thereby facilitating seed flow. In specific embodiments, the drying agents are built into the composition.

The drying agents can be a natural or synthetic solid material that is insoluble in water. This agent is generally inert and acceptable in agriculture, especially on the treated seed or other propagation material. It can be chosen, for example, from clay, diatomaceous earth, natural or synthetic silicates, titanium dioxide, magnesium silicate, aluminum silicate, talc, pyrophyllite clay, silica, attapulgite clay, dieselguhr, chalk, lime, calcium carbonate, bentonite clay, Fuller's earth, and the like.

A preferred combination of drying agents includes: (a) a fumed silica, (b) titanium dioxide, (c) a talc, and/or (d) a bentonite. These components can be present in varying ratios and amounts w/w.

### Colorant

A coloring agent, such as a dye or pigment is included in the seed coating so that an observer can immediately determine that the seeds are treated. The dye is also useful to indicate to the user the degree of uniformity of the coating applied and to differentiate between treated and untreated seeds. The colorant can be present in about 1-20% w/w, preferably about 2-15% w/w, and more preferably about 3-8% w/w.

### Antifoam

An antifoam additive can be added to reduce or eliminate the formation of foam during processing or use of the compositions. Antifoaming agents are known in the art and include, for example, silicones, such as polydimethylsiloxanes and other silicone derivatives.

### Thickener

In one embodiment, the thickener is present in the composition in an amount from about 0.01% to about 25% w/w, more specifically from 0.02 to 10% by weight of the entire composition. Thickeners are components used to adjust the viscosity of the compositions. Thickeners can be used to achieve the proper viscosity of the composition to allow the compositions to evenly cover seeds.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl, starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like.

As suitable thickeners there may also be mentioned attapulgite-type clay, carrageenan, croscarmellose sodium, furcelleran, glycerol, hydroxypropyl methylcellulose, polystyrene, vinylpyrrolidone/styrene block copolymer, hydroxypropyl cellulose, hydroxypropyl guar gum, and sodium carboxymethylcellulose. Xanthan gum is preferred.

### Binder

A binder can be included to ensure the composition properly adheres to the surface of the seed. If too much binder is included, germination of seeds may be affected. If too little binder is included, stability of coating may be affected resulting in cracks or chips. Binders can be present in about 1-20% w/w, alternatively about 1-10% w/w, preferred embodiments about 4-5% w/w, and alternatively 10-20% w/w or preferably about 15% w/w. Binders can be polymeric binders, latex binders, methyl cellulose, cellulose derivative, etc.

### Antifreeze

The composition can comprise, at least about 2 and up to about 25% w/w of at least one antifreeze agent, more specifically about 2-15% w/w, and more preferably about 5-10% w/w.

Specific examples of suitable antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and the like.

As a particular subset of suitable antifreeze materials there can be mentioned ethylene glycol, propylene glycol and glycerin.

### Flow Aids

Flow aids are used in seed treatments to positively affect the flow of seeds in a planter. Generally, such products reduce the resistance for the flow of seeds. Poor seed flow can result in slow or inconsistent handling of seeds in equipment negatively impacting planting. As used herein, flow aids generally refers to oil based flow aids. Such flow aids can include oils such as silicone oil, mineral oil, vegetable oil, natural or plant oil, or any synthetic oil.

Flow aids can be present in a range of 0.1 to 25% by weight. In preferred embodiments, flow aids can be present in a range of 2 to 15% by weight. As such, the flow aid can be present at, for example, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25% by weight, or any combination or value in-between.

### Preservative/Biocide

In some embodiments, the compositions contain preservative such as a microbiocide and biocide for preventing bacterial growth during storage. In one embodiment, the compositions contain both a microbicide such as Acticide® CT, a mixture containing 5-Chloro-2-methyl-2H-sothiazol-3-one and 2-Methyl-2H-isothiazol-3:one in a 3:1 ratio, which may be present in an amount ranging from about 0.02% w/w to about 0.8% w/w and biocide such as a dipropylene glycol solution of 1,2-benzisothiazolin-3-one (Proxel GXL), which may be present in an amount ranging from about 0.03% w/w to about 0.60% w/w.

The compositions herein can be formulated or mixed in the seed treater tank or combined on the seed by overcoating with other seed treating agents. The agents to be mixed with the compounds of this invention may be for the control of pests, nutrition, and the control of plant diseases.

### Process

The compositions can be prepared by processes known in the art.

In one embodiment, the aqueous compositions of the invention can be prepared by a process which comprises the steps: (a) forming a premix with at least one fungicidally active compound and at least one surfactant; (b) forming a premix of a carrier and water, and (c) sequentially adding the premixes (a) and (b) and the remaining ingredients to water while stirring to form a homogeneous composition.

In some embodiments, the process comprises: (a) preparing a concentrate and (b) diluting the concentrate with water or other diluent to reach desired concentration.

### SPECIFIC EMBODIMENTS

Embodiment 1. A composition, comprising:
at least one agrochemically active ingredient;
wherein the composition is a liquid;
wherein the composition is configured as a seed treatment; and
optionally wherein at least one of (a) to (1) is present:
(a) peanut seeds treated with the composition experience less than 2% splits when in a 50 lb bag and less than 7% splits when in a tote bag;
(b) peanut seeds treated with the composition do not increase the amount of splits by at least 0.25% total as compared to untreated seeds;
(c) peanut seeds treated with the composition are about twice as hard as untreated peanuts when measured by a compression clamp test at 15N and room temperature with a DMA (Dynamic Mechanical Analysis) Discovery 850 TA Instruments;
(d) peanut seeds treated with the composition have substantially similar water absorption as compared to untreated seeds;
(e) peanut seeds treated with the composition absorb about 0.5 to 1 g of water per seed as determined by adding 50 g of seeds to 100 g of water and calculating the absorbed water after 24 and 48 hours;
(f) peanut seeds treated with the composition have substantially similar germination as compared to untreated peanuts;
(g) peanut seeds treated with the composition have substantially similar vigor as compared to untreated peanuts;
(h) the composition dries at a rate of more than 0.115 wt % water loss/min at ambient conditions;
(i) peanut seeds treated with the composition have at least about 70% germination, preferably at least 75% germination, and most preferably at least 80% germination;
(j) peanut seeds treated with the composition generate less than 0.25 g dust per 100,000 seeds, preferably 0.2 g, and more preferably 0.15 g as measured by a Heubach test;
(k) build up of the composition in a seed treater for peanut seeds is less than 0.5 g, preferably less than 0.2 g, and most preferably 0.05 g as measured with retention coupons placed in the treater; and
(l) peanut seeds treated with the composition have a fresh flow rate is about at least 70% of untreated seeds.

Embodiment 2. The composition of Embodiment 1, wherein (a) is present.

Embodiment 3. The composition of Embodiment 1, wherein (b) is present.

Embodiment 4. The composition of Embodiment 1, wherein (c) is present.

Embodiment 5. The composition of Embodiment 1, wherein (d) is present.

Embodiment 6. The composition of Embodiment 1, wherein (e) is present.

Embodiment 7. The composition of Embodiment 1, wherein (f) is present.

Embodiment 8. The composition of Embodiment 1, wherein (g) is present.

Embodiment 9. The composition of Embodiment 1, wherein (h) is present.

Embodiment 10. The composition of Embodiment 1, wherein (i) is present.

Embodiment 11. The composition of Embodiment 1, wherein (j) is present.

Embodiment 12. The composition of Embodiment 1, wherein (k) is present.

Embodiment 13. The composition of Embodiment 1, wherein (1) is present.

Embodiment 14. The composition of Embodiment 1, wherein at least two of (a) to (1) are present.

Embodiment 15. The composition of Embodiment 1, wherein at least three of
(a) to (1) are present.

Embodiment 16. The composition of Embodiment 1, wherein at least four of (a) to (1) are present.

Embodiment 17. The composition of Embodiment 1, wherein at least five of (a) to (1) are present.

Embodiment 18. The composition of Embodiment 1, wherein at least six of (a) to (1) are present.

Embodiment 19. The composition of Embodiment 1, wherein at least seven of (a) to (1) are present.

Embodiment 20. The composition of Embodiment 1, wherein at least eight of (a) to (1) are present.

Embodiment 21. The composition of Embodiment 1, wherein at least nine of (a) to (1) are present.

Embodiment 22. The composition of Embodiment 1, wherein at least ten of (a) to (1) are present.

Embodiment 23. The composition of Embodiment 1, wherein at least eleven of (a) to (1) are present.

Embodiment 24. The composition of Embodiment 1, wherein all twelve of (a) to (1) are present.

Embodiment 25. The composition of any one of Embodiments 1-24, wherein the at least one agrochemically active ingredient includes a fungicide.

Embodiment 26. The composition of Embodiment 25, wherein the at least one agrochemically active ingredient includes at least two fungicides.

Embodiment 27. The composition of Embodiment 26, wherein the at least one agrochemically active ingredient includes at least two fungicides.

Embodiment 28. The composition of Embodiment 27, wherein the at least one agrochemically active ingredient includes at least three fungicides.

Embodiment 29. The composition of Embodiment 28, wherein the at least one agrochemically active ingredient includes at least four fungicides.

Embodiment 30. The composition of any one of Embodiments 1-29, wherein the at least one agrochemically active ingredient is selected from one or more of pydiflumetofen, azoxystrobin, sedaxane, fludioxonil, mefenoxam, and ipconazole.

Embodiment 31. The composition of any one of Embodiments 1-30, further comprising water.

Embodiment 32. The composition of any one of Embodiments 1-31, further wherein the total amount of agrochemical active ingredient in the composition is between about 2-40% w/w, preferably 5 to 35% w/w, more preferably 10 to 30% w/w, and most preferably 10 to 20% w/w.

Embodiment 33. The composition of any one of Embodiments 1-32, further comprising a drying system/agent.

Embodiment 34. The composition of Embodiment 33, wherein the drying system/agent is present in about 1 to 15% w/w, preferably about 3 to 10% w/w, and most preferably about 5 to 8% w/w.

Embodiment 35. The composition of either Embodiments 33 or 34, wherein the drying system/agent includes: a fumed silica, titanium dioxide, a talc, and/or a bentonite.

Embodiment 36. The composition of any one of Embodiments 1-35, further comprising a dispersant system/agent.

Embodiment 37. The composition of Embodiment 36, wherein the dispersant system/agent is about 2 to 15% w/w, preferably about 3 to 10% w/w, and most preferably 4 to 8% w/w.

Embodiment 38. The composition of either Embodiments 36 or 37, wherein the dispersant system/agent includes: an anionic tristyrylphenol phosphate surfactant; a tristyrylphenol ethoxylate nonionic emulsifier; an anionic tristyrylphenol sulfate surfactant; a butyl based block copolymer; and/or an acrylic copolymer solution.

Embodiment 39. The composition of any one of Embodiments 1-38, further comprising an oil lubricant system/agent.

Embodiment 40. The composition of Embodiment 39, wherein the oil lubricant system/agent is present from about 2 to 20% w/w, preferably from about 3 to 15% w/w, and more preferably about 4 to 12% w/w.

Embodiment 41. The composition of either Embodiments 39 or 40, wherein the oil lubricant system/agent is selected from a vegetable oil, and in preferred embodiments peanut oil, soybean oil, and/or castor oil.

Embodiment 42. The composition of any one of Embodiments 1-41, further comprising a wetting system/agent.

Embodiment 43. The composition of Embodiment 42, wherein the wetting system/agent is present from about 0.5 to 5% w/w, preferably from about 1 to 4% w/w, and more preferably from about 1.5 to 2.5% w/w.

Embodiment 44. The composition of either Embodiments 42 or 43, wherein the wetting system/agent includes: sodium lignosulphonate and/or a sodium salt of naphthalene sulfonate condensate.

Embodiment 45. The composition of any one of Embodiments 1-44, further comprising at least one of: an antifoam system/agent; a thickener system/agent; and a preservative system/agent.

Embodiment 46. The composition of Embodiment 45, wherein the antifoam system/agent; the thickener system/agent; and the preservative system/agent total less than about 2% w/w, preferably about 1.5%, and more preferably about 1%.

Embodiment 47. The composition of either Embodiments 45 or 46, wherein the antifoam system/agent includes silicone antifoam compound and the thickener system/agent includes xanthan gum.

Embodiment 48. The composition of any one of Embodiments 1-47, further comprising an anti-freeze system/agent.

Embodiment 49. The composition of Embodiment 48, wherein the antifreeze system/agent is present in an amount of about 2 to 15% w/w, and more preferably 5 to 10% w/w.

Embodiment 50. The composition of either Embodiments 48 or 49, wherein the antifreeze system/agent is propylene glycol.

Embodiment 51. The composition of any one of Embodiments 1-50, further comprising a colorant system/agent.

Embodiment 52. The composition of Embodiment 51, wherein the colorant system/agent is present in about 1 to 20% w/w, preferably about 2 to 15% w/w, and more preferably about 3 to 8% w/w.

Embodiment 53. The composition of any one of Embodiments 1-52, wherein water is present in the composition in about 50% w/w, alternatively about 60 to 90% w/w, and alternatively about 25 to 60% w/w.

Embodiment 54. The composition of any one of Embodiments 1-53, further comprising a binder system/agent.

Embodiment 55. The composition of Embodiment 54, wherein the binder system/agent is present in about 1 to 30% w/w, alternatively about 1 to 10% w/w, preferred embodiments about 4 to 5% w/w, and alternatively 10 to 25% w/w or preferably about 15% or about 20% w/w.

Embodiment 56. The composition of either Embodiments 54 or 55, wherein the binder system/agent is a polymeric binder, and including a latex binder.

Embodiment 57. A composition, comprising:
at least one agrochemically active ingredient between about 2-40% w/w, preferably 5 to 35% w/w, more preferably 10 to 30% w/w, and most preferably 10 to 20% w/w;
a drying system/agent between about 2 to 15% w/w, preferably about 3 to 10% w/w, and most preferably about 5 to 8% w/w;
a dispersant system/agent between about 2 to 15% w/w, preferably about 3 to 10% w/w, and most preferably 4 to 8% w/w;
an oil lubricant system/agent between about 2 to 20% w/w, preferably from about 3 to 15% w/w, and more preferably about 4 to 12% w/w;
a wetting system/agent between about 0.5 to 5% w/w, preferably from about 1 to 4% w/w, and more preferably from about 1.5 to 2.5% w/w;
an optional antifoam system/agent;
an optional thickener system/agent;
an optional preservative system/agent;
an optional anti-freeze system/agent, more particularly between about 2 to 15% w/w, and more preferably about 5 to 10% w/w;
an optional colorant agent/system, more particularly present in about 1 to 20% w/w, preferably about 2 to 15% w/w, and more preferably about 3 to 8% w/w;
an optional binder system/agent; and
water;
wherein, when an antifoam system/agent; a thickener system/agent; and a preservative system/agent are added into the composition, the antifoam system/agent; the thickener system/agent; and the preservative system/agent can total less than about 2% w/w, preferably about 1.5%, and more preferably about 1%.

Embodiment 58. A method, comprising: coating or applying the composition of any one of Embodiments 1-57 to a peanut.

Embodiment 59. The method of Embodiment 58, wherein at least one of (a) to (1) can be present:
(a) peanut seeds treated with the composition experience less than 2% splits when in a 50 lb bag and less than 7% splits when in a tote bag;
(b) peanut seeds treated with the composition do not increase the amount of splits by at least 0.25% total as compared to untreated seeds;
(c) peanut seeds treated with the composition are about twice as hard as untreated peanuts when measured by a compression clamp test at 15N and room temperature with a DMA (Dynamic Mechanical Analysis) Discovery 850 TA Instruments;
(d) peanut seeds treated with the composition have substantially similar water absorption as compared to untreated seeds;
(e) peanut seeds treated with the composition absorb about 0.5 to 1 g of water per seed as determined by adding 50 g of seeds to 100 g of water and calculating the absorbed water after 24 and 48 hours;
(f) peanut seeds treated with the composition have substantially similar germination as compared to untreated peanuts;
(g) peanut seeds treated with the composition have substantially similar vigor as compared to untreated peanuts;
(h) peanut seeds treated with the composition dry within 50 minutes, preferably 45 or 30 minutes, more preferably 20 minutes, and most preferably 15 minutes of completion of application at ambient conditions;
(i) peanut seeds treated with the composition have at least about 70% germination, preferably at least 75% germination, and most preferably at least 80% germination;
(j) peanut seeds treated with the composition generate less than 0.25 g dust per 100,000 seeds, preferably 0.2 g, and more preferably 0.15 g as measured by a Heubach test;
(k) build up of the composition in a seed treater for peanut seeds is less than 0.5 g, preferably less than 0.2 g, and most preferably 0.05 g as measured with retention coupons placed in the treater; and
(1) peanut seeds treated with the composition have a fresh flow rate is about at least 70% of untreated seeds.

Embodiment 60. A peanut coated or treated with the composition of any one of Embodiments 1-57.

### EXAMPLES

The following examples illustrate some further aspects of the invention but are not intended to limit its scope. Where not otherwise specified throughout this specification and claims, percentages are w/w.

### Example 1—Formulations

The formulations shown in Table 1 below were prepared and tested.

TABLE 1

| | Composition of tested formulations | | | | | | |
|---|---|---|---|---|---|---|---|
| | Active | Ex. 1 | Ex. 2 | Ex. 3 | Ex. 4 | Ex. 5 | Ex. 6 |
| | Ingredient | [% w/w] | [% w/w] | [% w/w] | [% w/w] | [% w/w] | [% w/w] |
| Active | APN | 0.00 | 0.00 | 0.00 | 0.00 | 0.00 | 6.85 |
| ingredients | Technical | | | | | | |
| | AZ | 11.23 | 11.23 | 11.1142 | 14.68 | 11.23 | 11.04 |
| | Technical | | | | | | |
| | SDX | 3.39 | 3.39 | 3.3601 | 4.44 | 3.39 | 3.34 |
| | Technical | | | | | | |
| | FDL | 3.52 | 3.52 | 3.4894 | 4.61 | 3.52 | 3.47 |
| | Technical | | | | | | |
| | Mefenoxam | 0.65 | 0.65 | 0.6462 | 0.85 | 0.65 | 0.64 |
| | Ipconazole | 0.00 | 0.00 | 0.00 | 0.00 | 1.74 | 0.00 |
| Antifreeze | Propylene | 6.49 | 6.49 | 6.485 | 7.77 | 6.49 | 6.79 |
| | Glycol | | | | | | |
| Dispersant | Soprophor | 0.51 | 0.89 | 0.508 | 0.57 | 0.89 | 0.92 |
| system | 3D33 | | | | | | |
| | Soprophor | 0.08 | 0.08 | 0.078 | 0.10 | 0.08 | 0.08 |
| | BSU | | | | | | |
| | Soprophor | 2.00 | 2.00 | 2.000 | 2.68 | 2.00 | 2.00 |
| | 4D384 | | | | | | |
| | Toximul | 1.32 | 1.32 | 1.302 | 0.95 | 1.32 | 1.41 |
| | 8320 | | | | | | |
| | Atlox 4913 | 1.00 | 1.00 | 1.00 | 1.00 | 1.00 | 1.00 |
| Wetting | Ultrazine | 0.97 | 0.97 | 0.96 | 0.66 | 0.97 | 0.99 |
| agents | NA | | | | | | |
| | Morwet | 1.20 | 1.20 | 1.19 | 1.23 | 1.20 | 1.22 |
| | D425 | | | | | | |
| Antifoam | Antifoam | 0.19 | 0.19 | 0.19 | 0.08 | 0.19 | 0.20 |
| | 1500 | | | | | | |
| thickener | Rhodopol | 0.16 | 0.16 | 0.16 | 0.16 | 0.16 | 0.16 |
| | 23 | | | | | | |
| Biocide/ | Acticide | 0.05 | 0.05 | 0.05 | 0.05 | 0.05 | 0.05 |
| preservative | CT | | | | | | |
| Colorant | Irgalite | 0.00 | 0.00 | 0.00 | 4.50 | 0.00 | 0.00 |
| | Red 48:2 | | | | | | |
| Oil | Soybean Oil | 0.00 | 8.00 | 0.00 | 0.00 | 8.00 | 8.00 |
| lubricant | Peanut Oil | 8.00 | 0.00 | 0.00 | 0.00 | 0.00 | 0.00 |
| Biocide/ | Proxel GXL | 0.32 | 0.05 | 0.49 | 0.08 | 0.05 | 0.05 |
| preservative | | | | | | | |
| Drying | Aerosil | 1.20 | 0.32 | 0.32 | 0.22 | 0.32 | 0.33 |
| agents | 200 Silica | | | | | | |
| | TS6300 | 2.60 | 1.20 | 1.19 | 0.00 | 1.20 | 1.22 |
| | Chemours | | | | | | |
| | Silverline | 2.60 | 2.60 | 2.57 | 0.88 | 2.60 | 1.32 |
| | 002 Talc | | | | | | |
| | Volclay 325 | 0.15 | 0.15 | 0.15 | 0.00 | 0.15 | 0.17 |
| | mesh (dry) | | | | | | |
| Binder | Vinamul | 0.00 | 0.00 | 5.00 | 5.00 | 0.00 | 0.00 |
| | 18462 | | | | | | |
| | (latex) | | | | | | |
| | water | Rest | Rest | Rest | Rest | Rest | Rest |

| | Composition of tested formulations | | | | | |
|---|---|---|---|---|---|---|
| | Active | Ex. 7 | Ex. 8 | Ex. 9 | Ex. 10 | Ex. 11 |
| | Ingredient | [% w/w] | [% w/w] | [% w/w] | [% w/w] | [% w/w] |
| Active | APN | 6.69 | 6.69 | 6.85 | 6.69 | 0.00 |
| ingredients | Technical | | | | | |
| | AZ | 10.77 | 10.77 | 11.04 | 10.77 | 14.68 |
| | Technical | | | | | |
| | SDX | 3.26 | 3.26 | 3.34 | 3.26 | 4.44 |
| | Technical | | | | | |
| | FDL | 3.38 | 3.38 | 3.47 | 3.38 | 4.61 |
| | Technical | | | | | |
| | Mefenoxam | 0.63 | 0.63 | 0.64 | 0.63 | 0.85 |
| | Ipconazole | 0.00 | 0.00 | 0.00 | 0.00 | 0.00 |
| Antifreeze | Propylene | 7.89 | 7.88 | 6.79 | 7.89 | 7.77 |
| | Glycol | | | | | |
| Dispersant | Soprophor | 0.90 | 0.89 | 0.92 | 0.90 | 0.57 |
| system | 3D33 | | | | | |
| | Soprophor | 0.08 | 0.08 | 0.08 | 0.08 | 0.10 |
| | BSU | | | | | |
| | Soprophor | 2.68 | 2.68 | 2.00 | 2.68 | 2.43 |
| | 4D384 | | | | | |
| | Toximul | 1.38 | 1.36 | 1.41 | 1.38 | 0.95 |
| | 8320 | | | | | |
| | Atlox 4913 | 1.00 | 1.00 | 1.00 | 1.00 | 0 |
| Wetting | Ultrazine | 0.96 | 0.95 | 0.99 | 0.96 | 0.41 |
| agents | NA | | | | | |
| | Morwet | 1.19 | 1.17 | 1.22 | 1.19 | 1.23 |
| | D425 | | | | | |
| Antifoam | Antifoam | 0.22 | 0.21 | 0.20 | 0.22 | 0.08 |
| | 1500 | | | | | |
| thickener | Rhodopol | 0.15 | 0.15 | 0.16 | 0.15 | 0.13 |
| | 23 | | | | | |
| Biocide/ | Acticide | 0.05 | 0.05 | 0.05 | 0.05 | 0.05 |
| preservative | CT | | | | | |
| Colorant | Irgalite | 4.50 | 4.50 | 0.00 | 4.50 | 4.50 |
| | Red 48:2 | | | | | |
| Oil | Soybean Oil | 0.00 | 0.00 | 8.00 | 0.00 | 0.00 |
| lubricant | Peanut Oil | 0.00 | 0.00 | 0.00 | 0.00 | 0.00 |
| Biocide/ | Proxel GXL | 0.05 | 0.04 | 0.00 | 0.00 | 0.07 |
| preservative | | | | | | |
| Drying | Aerosil | 0.32 | 0.32 | 0.33 | 0.32 | 0.22 |
| agents | 200 Silica | | | | | |
| | TS6300 | 1.19 | 1.27 | 1.22 | 1.19 | 0.00 |
| | Chemours | | | | | |
| | Silverline | 1.29 | 1.27 | 1.32 | 1.29 | 0.88 |
| | 002 Talc | | | | | |
| | Volclay 325 | 0.02 | 0.02 | 0.17 | 0.02 | 0.00 |
| | mesh (dry) | | | | | |
| Binder | Vinamul | 0.00 | 4.00 | 0.00 | 0.00 | 3.00 |
| | 18462 | | | | | |
| | (latex) | | | | | |
| | water | Rest | Rest | Rest | Rest | Rest |

APN = pydiflumetofen
AZ = azoxystrobin
SDX = sedaxane
FDL = fludioxonil

Ex. 1-3 and Ex. 5-10 were applied to peanuts at application rates of 2 fl oz, Ex. 4 and 11 was applied to peanuts at a rate of 1.5 fl oz. During the application process, in a tank mix was optionally added: polymeric binder, Milliken 2103 at 2 fl oz, Color Coat Red colorant at 0.5 fl oz, and water to bring the entire composition to 13 fl oz.

### Example 2—Slurry Water Loss and Drying

Formulations from Example 1 were tested for slurry water loss over time and drying ability. As Benchmark 1, a mixture of Maxim® 4FS (flowable concentrate of 40.3% w/w fludioxonil)+Dynasty® (flowable concentrate of 9.6% w/w azoxystrobin)+Apron XL® (flowable concentrate of 33.3% w/w mefenoxam)+Vibrance® 500FS (flowable concentrate of 43.7% w/w sedaxane) was used. Each individual tank mix seed treatment products. As Benchmark 2, a mixture of control 1+Saltro® 420FS (flowable concentrate of 41.7% w/w pydiflumetofen) was used.

Treatment slurries are prepared by diluting formulations+colorants or formulation+binder or formulations+binder+colorants with water to the predetermined slurry volume. Clear Inkjet transparency film sheets were weighed dry on a four digit analytical balance. Using an electric coater (RK Control) and a wire application rod (#25 bar), about 0.5 g of slurry was evenly coated onto the pre-weighed mylar sheet. The weight of the wet applied coating was determined by subtracting the weight of coating+mylar minus weight of mylar only.

The weight loss due to water evaporation was recorded every minute until there is no weight change anymore. The time and amount of water loss were used to calculate the drying rate of the slurry. Duplicate measurements were conducted and the percent average water loss per min was determined.

A comparison between the benchmark tank mixes of formulations of the same active ingredients+colorants and/or binders and the formulation+colorants and/or binders showed significant differences in drying rates with the invention formulations drying much faster than the corresponding tank mixtures.

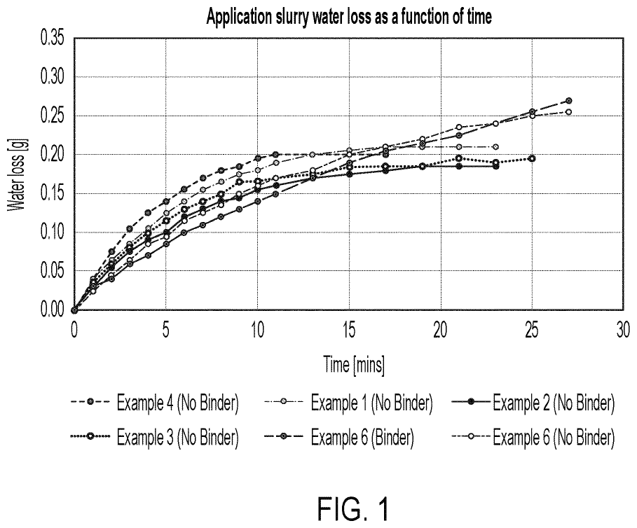

The higher the average drying rate the more likely the coating was to lose water and the more likely to dry faster. The results for slurry water loss are provided in FIG. 1 and Table 2 provides the application slurry drying rates.

TABLE 2

| | | | | Average | | |
|---|---|---|---|---|---|---|
| | wt % Water | Time | Drying rate | Drying rate | | |
| | loss on | to dry | [wt % water | [wt % water | | |
| Sample | drying | [min] | loss/min] | loss/min] | STD | Description |
| 1 | 3.354 | 29 | 0.116 | 0.119 | 0.004 | Ex. 6 + CC Red + |
| 2 | 3.277 | 27 | 0.121 | | | Milliken 2103 |
| | | | | | | Binder |
| 3 | 2.972 | 25 | 0.119 | 0.120 | 0.002 | Ex. 7 + Milliken |
| 4 | 3.270 | 27 | 0.121 | | | 2103 Binder |
| 5 | 3.256 | 29 | 0.112 | 0.114 | 0.002 | Benchmark 2 + CC |
| 6 | 2.882 | 25 | 0.115 | | | Red + Milliken |
| | | | | | | 2103 Binder |
| 7 | 3.542 | 43 | 0.082 | 0.084 | 0.002 | Benchmark 1 + CC |
| 8 | 4.025 | 47 | 0.086 | | | Red + Milliken |
| | | | | | | 2103 Binder |
| 9 | 2.103 | 11 | 0.191 | 0.194 | 0.003 | Ex. 4 (1.5 fl oz) |
| 10 | 2.353 | 12 | 0.196 | | | No Binder |
| 11 | 2.556 | 19 | 0.135 | 0.136 | 0.001 | Ex. 1 (2 fl oz) + |
| 12 | 2.595 | 19 | 0.137 | | | CC Red (No Binder) |
| 13 | 3.108 | 23 | 0.135 | 0.135 | 0.001 | Ex. 2 (2 fl oz) + |
| 14 | 2.550 | 19 | 0.134 | | | CC Red (No Binder) |
| 15 | 3.191 | 23 | 0.139 | 0.135 | 0.005 | Ex. 3 (2 fl oz) + |
| 16 | 2.760 | 21 | 0.131 | | | CC Red (No Binder) |
| 17 | 3.263 | 35 | 0.093 | 0.093 | 0.0001 | Benchmark 1 + CC |
| 19 | 3.256 | 35 | 0.093 | | | Red (No Binder) |

As illustrated by the above data, formulations disclosed herein had faster drying rates than Benchmark formulations (which contain the same active ingredients).

### Example 3—DMA (Dynamic Mechanical Analysis) Cohesion Tests

Peanuts with and without formulation and Milliken 2103 Binder at three levels were evaluated using a DMA stress Control IsoStress experiment. Three different force levels (5,10, 15N) were applied to the treated seeds with tesla (skin) on a compression clamp. The deformation of the clamped seed was measured as a function of temperature.

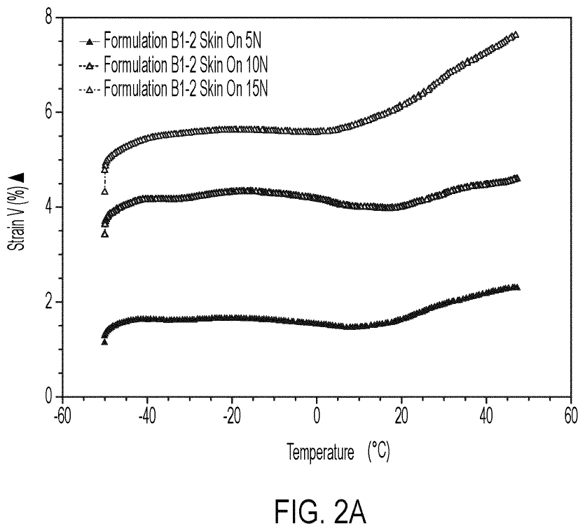

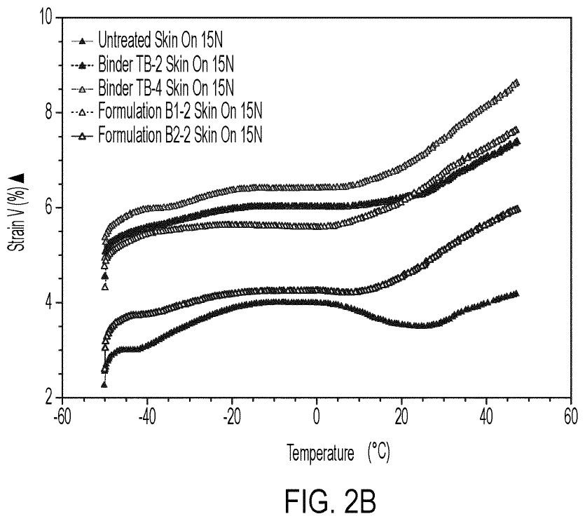

Samples treated with binder alone showed increased deformation with increasing binder levels. Samples treated with binder+formulation showed the opposite effect. Deformation of the peanut seed decreased when the binder loading increased. Seed skin cohesion appeared reinforced through the use of formulations in the treated slurry. The results are provided in FIGS. 2a and 2b, Table 3 describes each formulation.

TABLE 3

| Treatment | Description |
|---|---|
| B1-2 | Water + Ex. 6 (no binder) |
| B2-2 | Ex. 6 + 1 fl oz Binder |
| TB-2 | 1 fl oz Binder (no formulation) |
| TB-4 | 3 fl oz Binder (no formulation) |

### Example 4—Water Absorption

Water absorption was assessed for treated Spanish, GA 06, and Sullivan varieties using the following procedure. 50 g of seeds were weighted out and 100 g of water were added. After 24 hours and 48 hours, the excess water was mopped up and the seeds were reweighed. For this study, the seeds were treated with 13 fl oz/cwt of the formulation using a rotostat speed of 220 rpm. The results are provided below in Table 4.

TABLE 4

| Uncolored formulation Ex. 6 | | | | | Untreated Seeds | | | |
|---|---|---|---|---|---|---|---|---|
| | Water [g]/50 | | Water | | Water [g]/50 | | Water | |
| | g seeds | | [g]/seed | | g seeds | | [g]/seed | |
| | 24 h | 48 h | 24 h | 48 h | 24 h | 48 h | 24 h | 48 h |
| Spanish | 26.36 | 26.53 | 0.98 | 0.99 | 26.51 | 25.69 | 0.99 | 0.95 |
| GA 06 | 22.2 | 20.73 | 0.65 | 0.60 | 22.89 | 21.83 | 0.67 | 0.64 |
| Sullivan | 27.44 | 26.61 | 0.69 | 0.67 | 28.36 | 27.24 | 0.71 | 0.68 |
| Colored formulation Ex. 7 | | | | | Untreated Seeds | | | |
| | Water [g]/50 | | Water | | Water [g]/50 | | Water | |
| | g seeds | | [g]/seed | | g seeds | | [g]/seed | |
| | 24 h | 48 h | 24 h | 48 h | 24 h | 48 h | 24 h | 48 h |
| Spanish | 25.94 | 25.31 | 0.97 | 0.94 | 26.51 | 25.69 | 0.99 | 0.95 |
| GA 06 | 21.8 | 21.6 | 0.63 | 0.63 | 22.89 | 21.83 | 0.67 | 0.64 |
| Sullivan | 28.53 | 27.01 | 0.72 | 0.68 | 28.36 | 27.24 | 0.71 | 0.68 |

### Example 5—Field Testing

Peanuts were treated according to the formulations in Table 5.

TABLE 5

| Treatment | Product AI Rate Unit |
|---|---|
| 1 | CHECK UNTREATED |
| 2 | Dynasty ® PD (0.075 mg a/seed) |
| 3 | Dynasty ® (0.043 mg a/seed) + Maxim ® FS (0.027 mg |
| | a/seed) + Apron XL ® (0.005 mg a/seed) + Vibrance ® |
| | 500FS (0.026 mg a/seed) |
| 4 | Ex. 4 ((97.8 ml/100 kg) (275.9 g ai/L)) |
| 5 | Ex. 1 ((130 ml/100 kg) (206.9 g ai/L)) |
| 6 | Ex. 2 ((130 ml/100 kg) (206.9 g ai/L)) |
| 7 | Ex. 3 ((130 ml/100 kg) (206.9 g ai/L)) |
| 8 | Rancona ® V PD ((1400 g/100 kg) (206.9 g ai/L)) |
| 9 | Dynasty ® (0.043 mg a/seed) + Maxim ® FS (0.027 mg |
| | a/seed) + Apron XL ® (0.005 mg a/seed) + Vibrance ® |
| | 500FS (0.026 mg a/seed) + Saltro ® 400FS (10 g a/100 kg) |
| 10 | Maxim ® FS (0.027 mg a/seed) + Apron XL ® (0.005 mg |
| | a/seed) + Vibrance ® 500FS (0.026 mg a/seed) + Saltro ® |
| | 400FS (10 g a/100 kg) |

Treated Peanuts were tested in the areas and against the targets indicated in table 6.

TABLE 6

| State | Target |
|---|---|
| TX | Rhizoctonia solani |
| MS | R. solani |
| NC | R. solani |
| GA | R. solani |
| W-TX | R. solani |
| GA | R. solani |
| TX | R. solani |
| NC | R. solani |
| GA | R. solani |
| W-TX | R. solani |
| GA | Aspergillus niger |
| GA | A. niger |

Prior to planting, one pint of peanut seed was removed from each treatment and the number of seeds that were split or that had cracks or missing seed coat were counted. Based on six trials, 4 locations indicated no apparent issues with damaged seed, one location indicated Ex. 4, Ex. 1, and Ex. 2 had over 3× the broken seed compared to the untreated and Dynasty® PD, and one location indicated Ex. 2 and Ex. 3 had almost 2× the broken seed compared to the untreated seeds. The differences in damaged seed were not reflected in stand counts.

Based on the trials, four of the early stands did not have significant differences between fungicide treatments. Two of the trials in late stands did not have significant differences between fungicide treatments. Nine of the trials did not have significant differences between fungicide treatments. For yields nine of the trials did not have significant differences between fungicide treatments. These results illustrate experimental liquid formulations were effective.

### Example 6—Seed Safety Study

Sullivan and ACI 236 peanuts were treated with the formulations of Table 7.

TABLE 7

| Treatment | Description |
|---|---|
| 1 | Dynasty ® PD (peanut dust formulation) |
| 2 | Rancona ® |
| 3 | Ex. 9 |
| 4 | Ex. 9 + Adeen ® (polymeric binder) |
| 5 | Ex. 10 |
| 6 | Ex. 10 + Adeen ® |

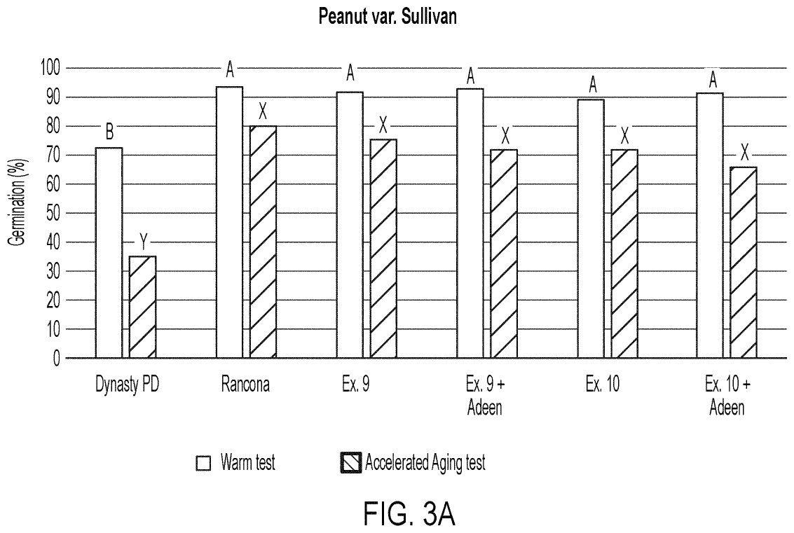

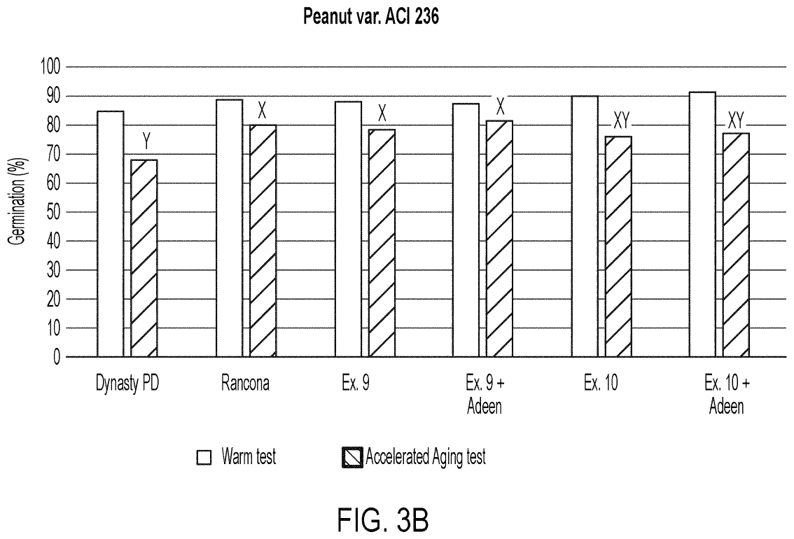

The seeds were tested for seed safety based on germination in warm and accelerated aging tests. The results are provided in FIGS. 3a and 3b. Different letters refer to statistically significant differences.

### Example 7—Flow Rates

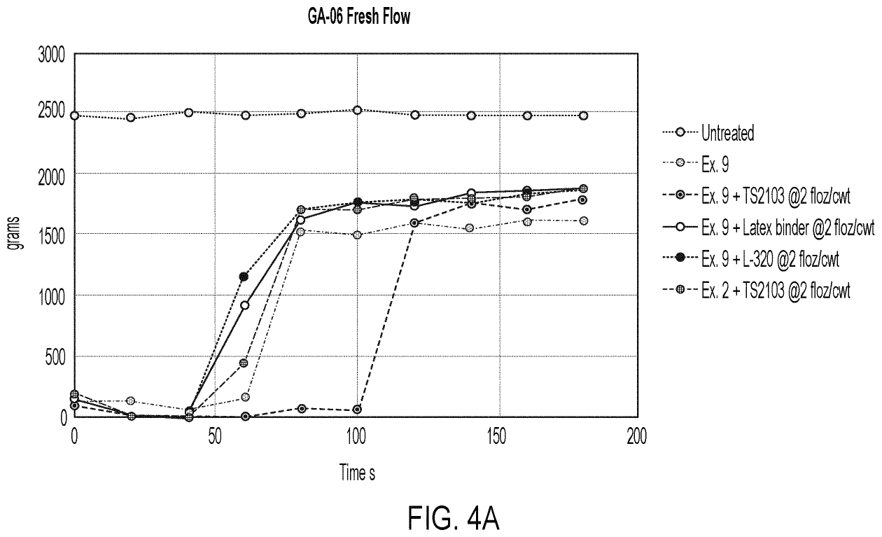

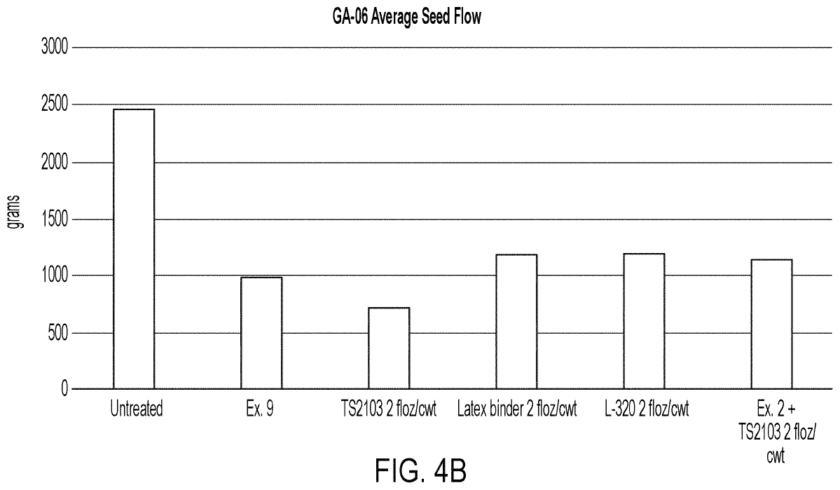

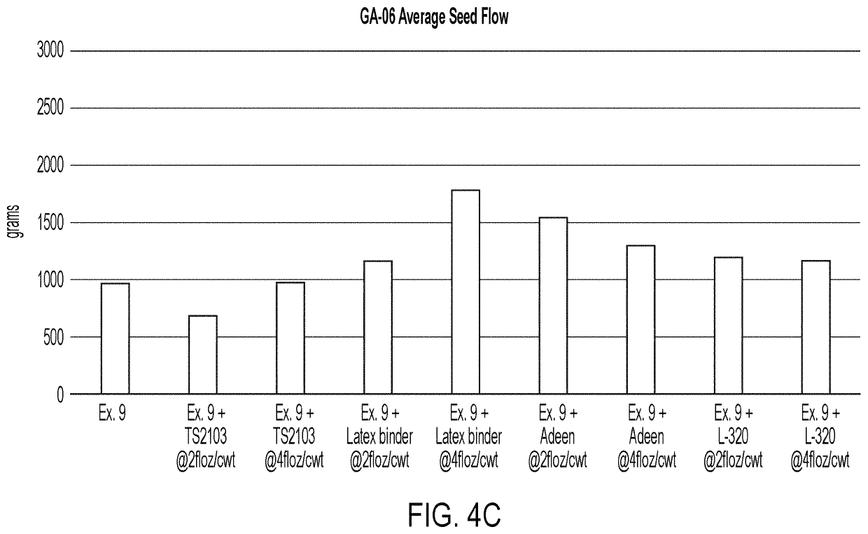

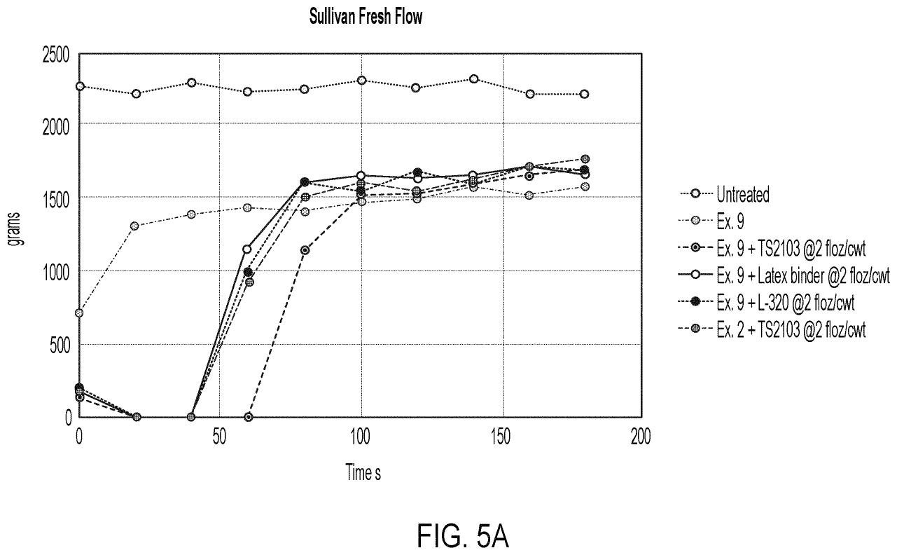

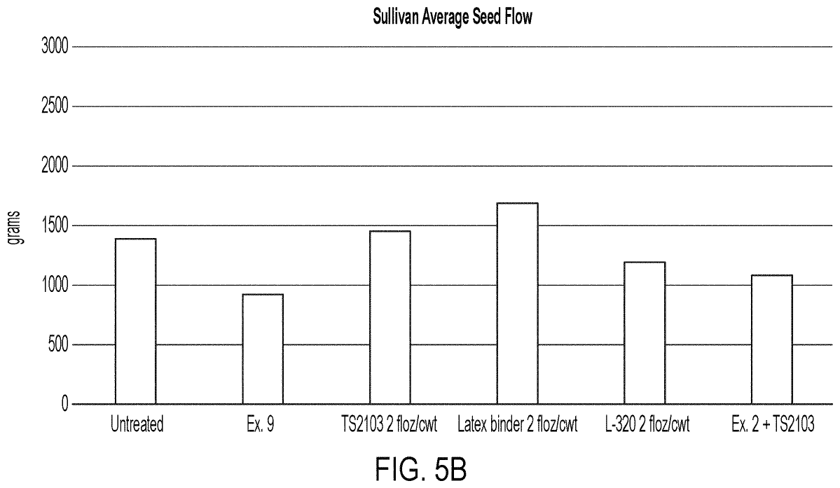

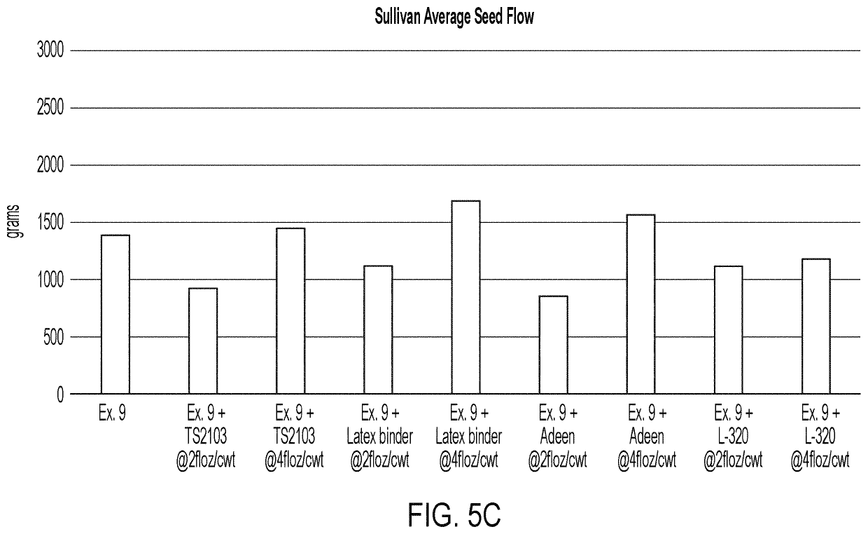

Sullivan and GA-06 peanuts were treated with various formulations and tested for their flow rates. The flow rate of the seeds were tested using the SCI Standard Seed Flow Test (version 1.0). The results are provided in FIGS. 4A-4C and 5A-5C.

### Example 8—Dust Off Measurements

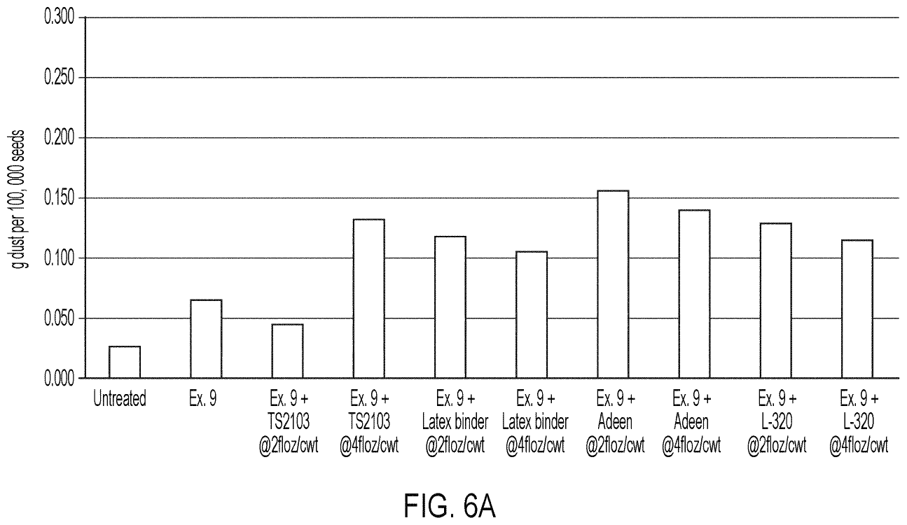

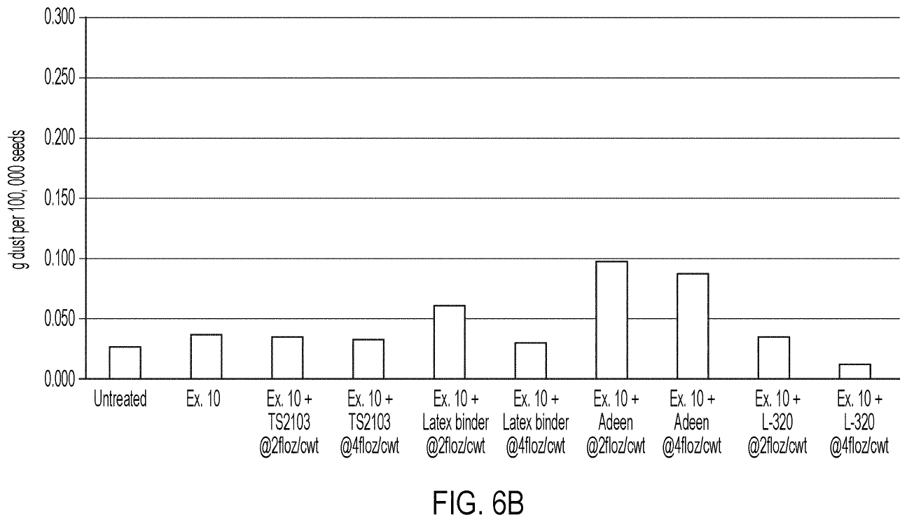

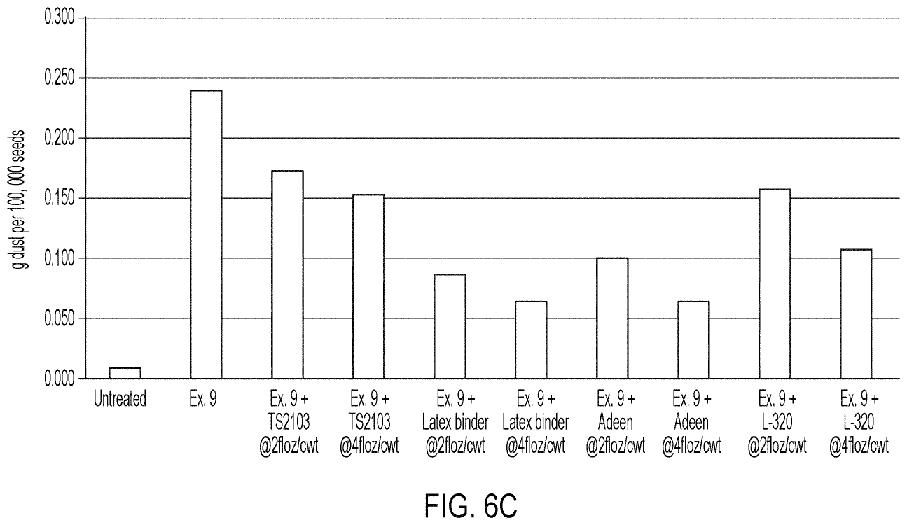

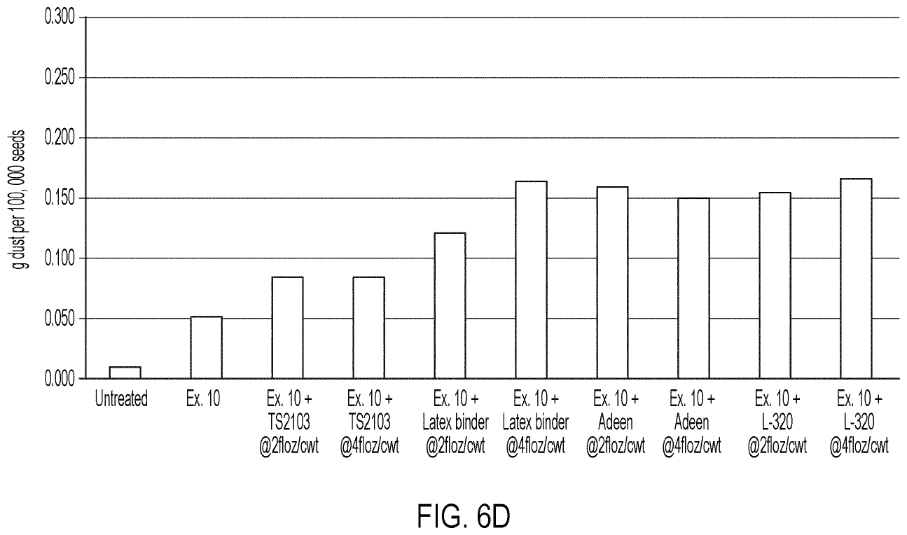

Dust measurement were taken from treated peanuts using the SCI Heubach Test Protocol (version 1.0). The results are provided in FIGS. 6A-6D. FIGS. 6A and 6B correspond to treatment of GA-06 peanuts and FIGS. 6C and 6D correspond to treatment of Sullivan peanuts.

### Example 9—Formulation Build-Up in Treater

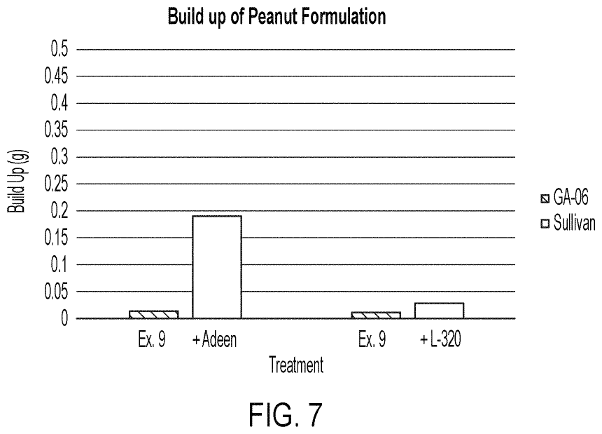

Peanuts were treated Cimbria Heid CC-20, batch treater, using formulations of Ex. 9+Adeen and Ex. 9+L-320. Deflectors were covered with rubber material to avoid damage/splitting of peanut seeds. Batch sizes were 18 Kg using a rotor speed of 25 Hz, 10 second application time, 16 second mixing time, and 7 second discharge time. The results of build-up on the treater are provided in FIG. 7.

### Example 10—Mechanical Damage

GA-06G, Sullivan, and Spanish peanuts were treated with the treatments in Table 8 and evaluated for damage and splitting.

TABLE 8

| | Rate (mg a.i./seed) |
|---|---|
| Treatment 1 | |
| Ex. 11 | 0.15 |
| Water | 3.978 |
| Treatment 2 | |
| Ex. 11 | 0.15 |
| Flo Rite ®1197 | 0.7588 |
| Water | 3.282 |
| Treatment 3 | |
| Ex. 11 | 0.15 |
| Flo Rite ®1197 | 1.5165 |
| Water | 2.586 |

* Flo Rite ®1197, available from BASF, is a plantability polymer product containing, inter alia, propylene glycol, methanol, resins, mica group minerals, and titanium dioxide.

In the process, seeds were dumped into a cup elevator and eventually into a hoper (4-5 foot drop) before entering the treating process. A CimbriaHeidCC-20, batch treater, was used to perform treatments. Deflectors were revested with rubber material to avoid damage/splitting on peanut seeds; batch size was 18 Kg, rotor speed was 25 Hz, application time was about 10-14 second, mixing time was about 12-14 seconds, and discharge time was about 7 seconds. Following treatment those seeds were then dropped 15-20 foot through a drop down ladder into the bagging station.

Mechanical damage was evaluated by counting seeds and the number of damaged ones. Across all three varieties the number of damaged seeds increased as seeds went through the treating and handling process. Georgia and Spanish presented very similar number across the treating process. Sullivan had a bigger variance within the treating and handling process. There was no substantial difference in mechanical damage level between treatments 1, 2 and 3 which represented different amounts of extra polymer added on the treatments.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

1. A composition, comprising:
at least one agrochemically active ingredient;
wherein the composition is a liquid;
wherein the composition is configured as a seed treatment; and
wherein the at least one agrochemically active ingredient includes at least three fungicides, and water.

2. The composition of claim 1, wherein the at least one agrochemically active ingredient is selected from one or more of pydiflumetofen, azoxystrobin, sedaxane, fludioxonil, mefenoxam, and ipconazole.

3. The composition of claim 1, further wherein the total amount of agrochemical active ingredient in the composition is between about 2-40% w/w, preferably 5 to 35% w/w, more preferably 10 to 30% w/w, and most preferably 10 to 20% w/w.

4. The composition of claim 1, further comprising a drying system/agent, wherein the drying system/agent is present in about 1 to 15% w/w, preferably about 3 to 10% w/w, and most preferably about 5 to 8% w/w, and wherein the drying system/agent includes: a fumed silica, titanium dioxide, a talc, and/or a bentonite.

5. The composition of claim 1, further comprising a dispersant system/agent, wherein the dispersant system/agent is about 2 to 15% w/w, preferably about 3 to 10% w/w, and most preferably 4 to 8% w/w, and wherein the dispersant system/agent includes: an anionic tristyrylphenol phosphate surfactant; a tristyrylphenol ethoxylate nonionic emulsifier; an anionic tristyrylphenol sulfate surfactant; a butyl based block copolymer; and/or an acrylic copolymer solution.

6. The composition of claim 1, further comprising an oil lubricant system/agent, wherein the oil lubricant system/agent is present from about 2 to 20% w/w, preferably from about 3 to 15% w/w, and more preferably about 4 to 12% w/w, and wherein the oil lubricant system/agent is selected from a vegetable oil, and in preferred embodiments peanut oil, soybean oil, and/or castor oil.

7. The composition of claim 1, further comprising a wetting system/agent, wherein the wetting system/agent is present from about 0.5 to 5% w/w, preferably from about 1 to 4% w/w, and more preferably from about 1.5 to 2.5% w/w, and wherein the wetting system/agent includes: sodium lignosulphonate and/or a sodium salt of naphthalene sulfonate condensate.

8. The composition of claim 1, further comprising at least one of: an antifoam system/agent; a thickener system/agent; and a preservative system/agent, wherein the antifoam system/agent; the thickener system/agent; and the preservative system/agent total less than about 2% w/w, preferably about 1.5%, and more preferably about 1%, and
further comprising an anti-freeze system/agent, wherein the antifreeze system/agent is present in an amount of about 2 to 15% w/w, and more preferably 5 to 10% w/w, and wherein the antifreeze system/agent is propylene glycol.

9. The composition of claim 1, wherein water is present in the composition in about 50% w/w, alternatively about 60 to 90% w/w, and alternatively about 25 to 60% w/w.

10. The composition of claim 1, further comprising a binder system/agent, wherein the binder system/agent is present in about 1 to 30% w/w, alternatively about 1 to 10% w/w, preferred embodiments about 4 to 5% w/w, and alternatively 10 to 25% w/w or preferably about 15% or about 20% w/w, and wherein the binder system/agent is a polymeric binder, and including a latex binder.

11. A composition, comprising:
at least one agrochemically active ingredient between about 2-40% w/w, preferably 5 to 35% w/w, more preferably 10 to 30% w/w, and most preferably 10 to 20% w/w;
a drying system/agent between about 2 to 15% w/w, preferably about 3 to 10% w/w, and most preferably about 5 to 8% w/w;
a dispersant system/agent between about 2 to 15% w/w, preferably about 3 to 10% w/w, and most preferably 4 to 8% w/w;
an oil lubricant system/agent between about 2 to 20% w/w, preferably from about 3 to 15% w/w, and more preferably about 4 to 12% w/w;
a wetting system/agent between about 0.5 to 5% w/w, preferably from about 1 to 4% w/w, and more preferably from about 1.5 to 2.5% w/w; and
water.

12. A composition according to claim 11, wherein it further comprises:
an antifoam system/agent;
a thickener system/agent; and
a preservative system/agent.

13. A composition according to claim 12, wherein the antifoam system/agent; the thickener system/agent; and the preservative system/agent total less than about 2% w/w, preferably about 1.5%, and more preferably about 1%.

14. A composition according to claim 11,
wherein it further comprises:
an anti-freeze system/agent, optionally between about 2 to 15% w/w, and more preferably about 5 to 10% w/w;
an optional colorant agent/system present in about 1 to 20% w/w, preferably about 2 to 15% w/w, and more preferably about 3 to 8% w/w; and
an optional binder system/agent.

15. A method, comprising: coating or applying the composition of claim 1 to a peanut, and more particularly to a peanut seed.

16. The method of claim 15, wherein the composition is further combined with at least one of a polymeric binder, colorant, or water prior to applying.
